(19) United States
(12) Patent Application Publication
(10) Pub. No.: US 2005/0159125 A1
(43) Pub. Date: Jul. 21, 2005

(54) One or more openly visible indicators that display wireless network signal strength

(76) Inventors: Luca Lodolo, Sunnyvale, CA (US); Ameer Karim, San Jose, CA (US); Michael Ip, Fremont, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/758,806

(22) Filed: Jan. 16, 2004

(51) Int. Cl. H04B 17/00

(52) U.S. Cl. 455/226.4; 455/566

(57) ABSTRACT

One or more openly visible indicators of a digital media receiver display a wireless network signal strength.

### BACKGROUND

Digital media receivers receive digital media signals (e.g. audio, video, and digital image signals) from digital media transmitters. For example, the digital media transmitters send the digital media signals through a wireless network to the digital media receivers. The wireless network in one example employs an 802.11 wireless network protocol. The digital media receiver in one example is coupled to a media playback device. For example, the digital media receiver receives the digital media signals from the wireless network and passes the digital media signals to the media playback device. The media playback device may be an audio/video receiver, television, alarm clock, or the like. A user of the digital media receiver in one example may access the digital media signals at the media playback devices.

The strength of a wireless connection between the digital media receiver and the digital media transmitter affects a quality of the digital media received at the digital media receiver. For example, the wireless connection comprises a wireless network signal strength. A higher signal strength level of the wireless network signal strength leads to a higher quality of the digital media received at the digital media receiver. The higher quality of the digital media received at the digital media receiver results in higher quality digital media at the media playback devices. The digital media receiver comprises one or more antennas that interface with the wireless network. The wireless network signal strength in one example is based on a position of the antenna. The user in one example may adjust one or more of the antennas attached to the digital media receiver to cause a change in the wireless network signal strength. For example, the user adjusts the antennas to increase the quality of the digital media signals by increasing the wireless network signal strength.

### SUMMARY

The invention in one implementation encompasses a digital media receiver. The digital media receiver comprises one or more openly visible indicators that display a wireless network signal strength.

Another implementation of the invention encompasses an apparatus. The apparatus comprises a digital media receiver application component that determines a signal strength level of a wireless network signal and employs one or more openly visible indicators to display the signal strength level.

Still another implementation of the invention encompasses an apparatus. The apparatus comprises means for classifying a wireless network signal into one of a plurality of signal strength levels. The apparatus comprises means for openly displaying an indication that the wireless network signal is at the one of the plurality of signal strength levels.

Yet another implementation of the invention encompasses a method. One or more wireless network signals employable by a digital media receiver are classified into one or more of a plurality of signal strength levels. The one or more of the plurality of signal strength levels are displayed with one or more openly visible indicators of the digital media receiver.

A further implementation of the invention encompasses an article. The article comprises one or more computer-readable signal-bearing media. The article includes means in the one or more media for classifying one or more wireless network signals employable by a digital media receiver into one or more of a plurality of signal strength levels. The article includes means in the one or more media for displaying the one or more of the plurality of signal strength levels with one or more openly visible indicators of the digital media receiver.

### DESCRIPTION OF THE DRAWINGS

Features of exemplary implementations of the invention will become apparent from the description, the claims, and the accompanying drawings in which:

FIG. 1 is a representation of an exemplary implementation of an apparatus that comprises a digital media receiver, one or more antennas, one or more network cards, one or more digital media receiver application components, one or more openly visible indicators, and a display component.

FIG. 2 is a representation of exemplary logic that serves to allow the digital media receiver application component to display a wireless network signal strength with one or more of the one or more indicators of the apparatus of FIG. 1.

### DETAILED DESCRIPTION

Referring to the BACKGROUND section above, the digital media receiver may employ a liquid crystal display to indicate the signal strength level of the wireless network signal strength. The digital media receiver also employs the liquid crystal display to display a title, date, time, and media type of the audio, video, and digital image signals. As one shortcoming, the signal strength level displayed by the liquid crystal display is not in plain view for the user of the digital media receiver to see. For example, the user may have to search through a menu displayed on the liquid crystal display to determine the wireless network signal strength. As another shortcoming, the user does not receive openly visible feedback as to a change in the signal strength level upon adjustment of a position of the antenna.

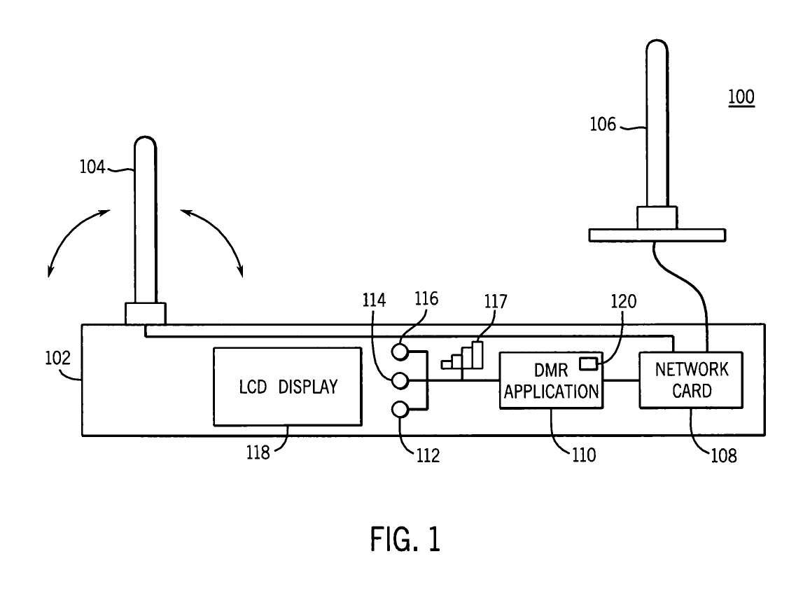

Turning to FIG. 1, the apparatus 100 in one example comprises a digital media receiver 102, one or more antennas 104 and 106, one or more network cards 108, one or more digital media receiver application components 110, one or more openly visible indicators 112, 114, 116, and 117, and a display component 118. One or more of the openly visible indicators 112, 114, 116, and 117 of the digital media receiver display a wireless network signal strength of a wireless network signal (e.g. an audio signal, a video signal, and/or a digital image signal).

The digital media receiver 102 in one example communicates with a computer through the wireless network. For example, the digital media receiver 102 receives the wireless network signal from a wireless network transmitter of the computer through the wireless network. The wireless network in one example employs an 802.11a, 802.11b, or 802.11g wireless network protocol to communicate the wireless network signal. The wireless network in one example comprises a home, business, or private wireless network.

The digital media receiver 102 in one example communicates information received from the wireless network signal to one or more media playback devices. The media playback devices in one example comprise one or more of a television, an audio/video receiver, a computer, an alarm clock, and the like. In one example, the digital media receiver 102 is coupled with the media playback devices. In another example, the digital media receiver 102 is an integral part of the media playback devices. A user of the digital media receiver 102 in one example employs the digital media receiver 102 to select one or more portions of the wireless network signal to be played on one or more of the media playback devices. For example, where the wireless network signal comprises digital images, the digital media receiver 102 shows the digital images to the user on a television.

The wireless network signal comprises a wireless network signal strength that affects a quality of the audio, video, and digital image signals received at the digital media receiver 102. For example, a higher signal strength level of the wireless network signal strength leads to a higher quality of the audio, video, and digital image signals received at the digital media receiver 102. The higher quality of the digital media received at the digital media receiver 102 results in higher quality audio, video, and digital images at the media playback devices.

The antennas 104 and/or 106 of the digital media receiver 102 receive the wireless network signal from the wireless network. The wireless network signal strength in one example is based on a position of the antennas 104 and/or 106. The user in one example may adjust one or more of the antennas 104 and 106 to cause a change in the wireless network signal strength. For example, the user adjusts the antennas 104 and/or 106 to increase the quality of the audio, video, and digital image signals by increasing the wireless network signal strength. The antenna 104 in one example comprises a swivel antenna. The antenna 106 in one example comprises a removable antenna.

The network card 108 obtains the wireless network signal from the antennas 104 and/or 106. The network card 108 in one example comprises a wireless network card. For example, the network card 108 employs the 802.11a, 802.11b, or 802.11g wireless network protocol to communicate the wireless network signal with one or more of the wireless network transmitter and the media playback devices. The digital media application component 110 in one example obtains the wireless network signal strength from the wireless network signal through the network card 108. For example, the digital media application component 110 processes the wireless network signal to determine the wireless network signal strength.

The digital media application component 110 in one example classifies the wireless network signal strength into one of a plurality of signal strength levels. For example, the digital media application component 110 makes a comparison of the wireless network signal strength with one or more one or more wireless signal threshold values. The digital media application component 110 employs the comparison to determine the one of the plurality of signal strength levels. The digital media application component 110 comprises an instance of the recordable data storage medium 120. In one example, the digital media application component 110 employs one or more of the openly visible indicators 112, 114, and 116 to display the one of the plurality of signal strength levels. In another example, the digital media application component 110 employs the openly visible indicator 117 to display that the wireless network signal strength is at the one of the plurality of signal strength levels.

One or more of the openly visible indicators 112, 114, 116, and 117 display the wireless network signal strength for the user of the digital media receiver 102. The openly visible indicators 112, 114, 116, and 117 in one example comprise one or more stand-alone displays. For example, the openly visible indicators 112, 114, 116, and 117 are separate from the display component 118 (e.g. a liquid crystal display). The openly visible indicators 112, 114, 116, and 117 in one example allow the user to plainly view the wireless network signal strength. For example, the openly visible indicators 112, 114, 116, and 117 provide immediate feedback of the wireless network signal strength for the user. If the wireless network signal strength has decreased, the openly visible indicators 112, 114, 116, and 117 indicate that the wireless network signal strength has decreased. The user will see the openly visible indicators 112, 114, 116, and 117 and notice the decrease in the wireless network signal strength. Thus, the user may attempt to correct the decrease in the wireless network signal strength.

In one example, the user can adjust the position of the antennas 104 and/or 106 to attempt to increase the wireless network signal strength at the digital media receiver 102. For example, the user views the wireless network signal strength with the openly visible indicators 112, 114, 116, and 117 while adjusting the position of the antennas 104 and/or 106 to place the antennas 104 and/or 106 in a position that gives a higher quality wireless network signal strength. Upon, successful increase in the wireless network signal strength, the openly visible indicators 112, 114, 116, and 117 display that the signal is back to a higher signal strength level.

In one example, the digital media receiver application component 110 employs one of the openly visible indicators 112, 114, and 116 to display the wireless network signal strength level. The openly visible indicator 112, 114, or 116 in one example comprises a light emitting diode capable of displaying any one of a plurality of colors. The digital media receiver application component 110 in one example switches to the one of the plurality of colors upon a change in the wireless network signal strength. For example, the openly visible indicator 112, 114, or 116 displays a green, yellow, or red color to indicate an excellent, a good, or a poor signal strength level respectively.

In another example, the digital media receiver component 110 employs the openly visible indicators 112, 114, and 116 to display the wireless network signal strength level. The openly visible indicators 112, 114, and 116 in one example comprise light emitting diodes each capable of displaying a different color. The digital media receiver application component 110 switches on the openly visible indicator 112 upon a change in the wireless network signal strength to an excellent signal strength level. The digital media receiver application component 110 switches on the openly visible indicator 114 upon a change in the wireless network signal strength to a good signal strength level. The digital media receiver application component 110 switches on the openly visible indicator 116 upon a change in the wireless network signal strength to a poor signal strength level.

In yet another example, the digital media receiver application component 110 employs one or more of the openly visible indicators 112, 114, and 116 to display the wireless network signal strength level. At a poor wireless network signal strength, the digital media receiver application component 110 in one example switches on the openly visible indicator 112. At an excellent wireless network signal strength, the digital media receiver application component 110 in one example switches on the openly visible indicators 112, 114, and 116.

In still another example, the digital media receiver application component 110 employs the openly visible indicator 117 to display the wireless network signal strength level. The openly visible indicator 117 comprises one or more status bar indicators capable of displaying a plurality of status bar sizes. For example, the digital media receiver application component 110 changes one or more of the plurality of status bar sizes of the openly visible indicator 117 upon a change in the wireless network signal strength.

Where the wireless network signal comprises the audio signal, the digital media receiver application component 110 in one example obtains an audio signal strength from the wireless network card 108. The digital media receiver application component 110 employs the audio signal strength to determine one of a plurality of audio signal strength levels. The digital media receiver application component 110 in one example makes a comparison of the one of the plurality of audio signal strength levels with a first audio signal threshold value. If the one of the plurality of audio signal strength levels surpasses the first audio signal threshold value, then the digital media receiver application component 110 employs the comparison to display that the one of the plurality of audio signal strength levels surpasses the first audio threshold value with one or more of the indicators 112, 114, 116, and 117. If the one of the plurality of audio signal strength levels does not surpass the first audio signal threshold value, then the digital media receiver application component 110 makes a comparison of the one of the plurality of audio signal strength levels with a second audio threshold value.

Where the wireless network signal comprises the video signal, the digital media receiver application component 110 in one example obtains an video signal strength from the wireless network card 108. The digital media receiver application component 110 employs the video signal strength to determine one of a plurality of video signal strength levels. The digital media receiver application component 110 in one example makes a comparison of the one of the plurality of video signal strength levels with a first video signal threshold value. If the one of the plurality of video signal strength levels surpasses the first video signal threshold value, then the digital media receiver application component 110 employs the comparison to display that the one of the plurality of video signal strength levels surpasses the first video signal threshold with one or more of the indicators 112, 114, 116, and 117. If the one of the plurality of video signal strength levels does not surpass the first video signal threshold value, then the digital media receiver application component 110 makes a comparison of the one of the plurality of video signal strength levels with a second video threshold value.

Where the wireless network signal comprises the digital image signal, the digital media receiver application component 110 in one example obtains an digital image signal strength from the wireless network card 108. The digital media receiver application component 110 employs the digital image signal strength to determine one of a plurality of digital image signal strength levels. The digital media receiver application component 110 in one example makes a comparison of the one of the plurality of digital image signal strength levels with a first digital image signal threshold value. If the one of the plurality of digital image signal strength surpasses the first digital image signal threshold value, then the digital media receiver application component 110 employs the comparison to display that the one of the plurality of digital image signal strength levels surpasses the first digital image signal threshold value with one or more of the indicators 112, 114, 116, and 117. If the one of the plurality of digital image signal strength levels does not surpass the first digital image signal threshold value, then the digital media receiver application component 110 makes a comparison of the one of the plurality of digital image signal strength levels with a second digital image threshold value.

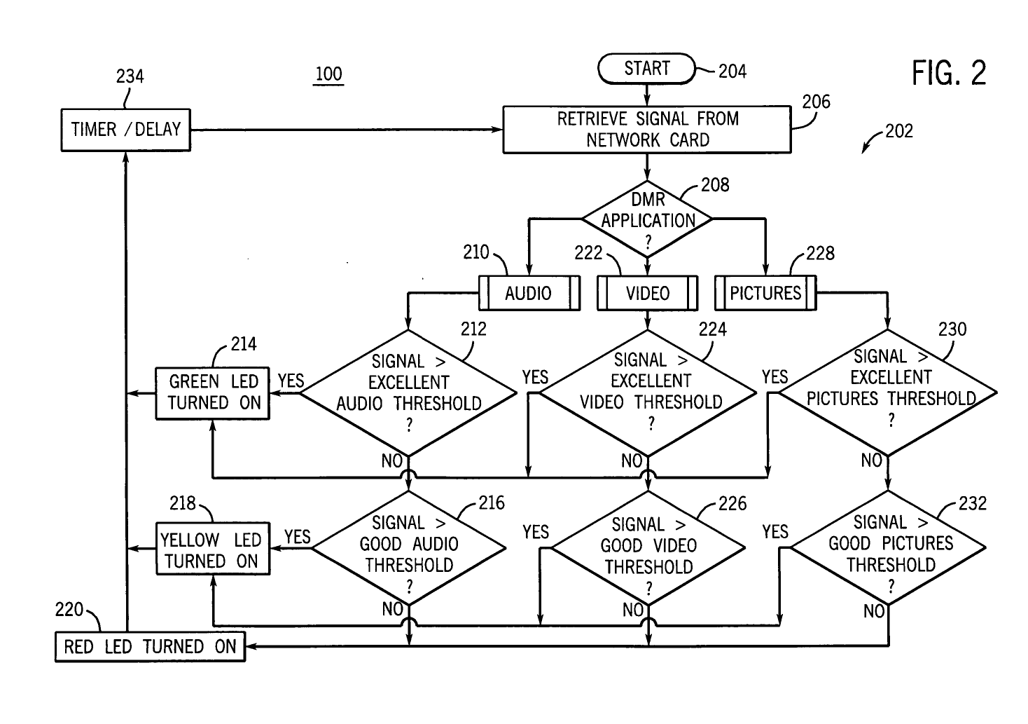

Referring to FIGS. 1-2, exemplary logic 202 serves to allow the digital media receiver application component 110 to display a wireless network signal strength with one or more openly visible indicators 112, 114, 116, and 117, as described herein. The apparatus 100 can compare a signal strength level of the wireless network signal strength with one or more signal threshold values to display that the wireless network signal strength is at the signal strength level. The logic 202 employs one or more steps, for example, STEPS 204, 206, 208, 210, 212, 214, 216, 218, 220, 222, 224, 226, 228, 230, 232, and 234.

The digital media receiver application component 110 in one example obtains the wireless network signal strength of a wireless network signal (e.g. one or more of an audio signal, a video signal, and a digital image signal) from the network card 108. The digital media receiver application component 110 compares one or more signal strength levels of the wireless network signal with one or more signal strength threshold values (e.g. one or more of an audio signal strength threshold value, a video signal strength threshold value, and a digital image signal strength threshold value). The openly visible indicators 112, 114, 116, and 117 display the signal strength levels that surpass one or more of the one or more signal strength threshold values.

While the digital media receiver 102 is turned on, the network card 108 communicates one or more wireless network signals between one or more of a television, an audio/video receiver, a computer, and an alarm clock through a wireless network, and STEP 204 proceeds to STEP 206. The digital media receiver application component 110 obtains a wireless network signal from the network card 108, and STEP 206 proceeds to step 208. Upon receipt of the wireless network signal from the network card 108, the digital media receiver application component 110 in one example employs the wireless network signal to make a determination of the wireless network signal strength. For example, the digital media receiver application component 110 processes the wireless network signal to determine the wireless network signal strength and STEP 208 proceeds to STEPS 210, 222, and/or 228. The wireless network signal strength comprises one or more of an audio signal strength level, video signal strength level, and a digital image signal strength level.

If the wireless network signal strength comprises the audio signal strength level, then STEP 210 proceeds to STEP 212. The digital media receiver application component 110 compares the audio signal strength level to a first audio signal strength threshold value. If the audio signal strength level surpasses the first audio signal strength threshold value, then the digital media receiver application component 110 in one example employs one or more of the openly visible indicators 112, 114, 116, and 117 to display that the audio signal strength level surpasses the first audio signal strength threshold value, and STEP 212 proceeds to STEP 214.

If the audio signal strength level does not surpass the first audio signal strength threshold value, then STEP 212 proceeds to STEP 216. The digital media receiver application component 110 compares the audio signal strength level to a second audio signal strength threshold value. If the audio signal strength level surpasses the second audio signal strength threshold value, then the digital media receiver application component 110 in one example employs one or more of the openly visible indicators 112, 114, 116, and 117 to display that the audio signal strength level surpasses the second audio signal strength threshold value, and STEP 216 proceeds to STEP 218. If the audio signal strength level does not surpass the second audio signal strength threshold value, then the digital media receiver application component 110 in one example employs one or more of the openly visible indicators 112, 114, 116, and 117 to display that the audio signal strength level does not surpass the second audio signal strength threshold value, and STEP 216 proceeds to STEP 220.

If the wireless network signal strength comprises the video signal strength level, then STEP 222 proceeds to STEP 224. The digital media receiver application component 110 compares the video signal strength level to a first video signal strength threshold value. If the video signal strength level surpasses the first video signal strength threshold value, then the digital media receiver application component 110 in one example employs one or more of the openly visible indicators 112, 114, 116, and 117 to display that the video signal strength level surpasses the first video signal strength threshold value, and STEP 224 proceeds to STEP 214.

If the video signal strength level does not surpass the first video signal strength threshold value, then STEP 224 proceeds to STEP 226. The digital media receiver application component 110 compares the video signal strength level to a second video signal strength threshold value. If the video signal strength level surpasses the second video signal strength threshold value, then the digital media receiver application component 110 in one example employs one or more of the openly visible indicators 112, 114, 116, and 117 to display that the video signal strength level surpasses the second video signal strength threshold value, and STEP 226 proceeds to STEP 218. If the video signal strength level does not surpass the second video signal strength threshold value, then the digital media receiver application component 110 in one example employs one or more of the openly visible indicators 112, 114, 116, and 117 to display that the video signal strength level does not surpass the second video signal strength threshold value, and STEP 226 proceeds to STEP 220.

If the wireless network signal strength comprises the digital image signal strength level, then STEP 228 proceeds to STEP 230. The digital media receiver application component 110 compares the digital image signal strength level to a first digital image signal strength threshold value. If the digital image signal strength level surpasses the first digital image signal strength threshold value, then the digital media receiver application component 110 in one example employs one or more of the openly visible indicators 112, 114, 116, and 117 to display that the digital image signal strength level surpasses the first digital image signal strength threshold value, and STEP 230 proceeds to STEP 214.

If the digital image signal strength level does not surpass the first digital image signal strength threshold value, then STEP 230 proceeds to STEP 232. The digital media receiver application component 110 compares the digital image signal strength level to a second digital image signal strength threshold value. If the digital image signal strength level surpasses the second digital image signal strength threshold value, then the digital media receiver application component 110 in one example employs one or more of the openly visible indicators 112, 114, 116, and 117 to display that the digital image signal strength level surpasses the second digital image signal strength threshold value, and STEP 232 proceeds to STEP 218. If the digital image signal strength level does not surpass the second digital image signal strength threshold value, then the digital media receiver application component 110 in one example employs one or more of the openly visible indicators 112, 114, 116, and 117 to display that the digital image signal strength level does not surpass the second digital image signal strength threshold value, and STEP 232 proceeds to STEP 220.

STEPS 214, 218, and 220 proceed to STEP 234 upon a change in an indicator state of one or more of the openly visible indicators 112, 114, 116, and 117. In one example, the digital media receiver 110 changes a color of the indicator 112 to green, and STEP 214 proceeds to STEP 234. In another example, the digital media receiver application component 110 switches off the openly visible indicator 112 and switches on the openly visible indicator 114, and STEP 218 proceeds to STEP 234. For example, the openly visible indicator 114 comprises a yellow color. In still another example, the digital media receiver application component 110 switches off the openly visible indicator 114 and switches on the openly visible indicator 116, and STEP 220 proceeds to STEP 234. Upon the change in the indicator state of the one or more of the openly visible indicators 112, 114, 116, and 117, the digital media receiver application component 110 in one example sets a timer. For example, the digital media receiver application component 110 waits until the timer expires, and STEP 234 proceeds back to STEP 206. The digital media receiver application component 110 can now obtain the wireless network strength level again.

The apparatus 100 in one example comprises a plurality of components such as one or more of electronic components, hardware components, and computer software components. A number of such components can be combined or divided in the apparatus 100. An exemplary component of the apparatus 100 employs and/or comprises a set and/or series of computer instructions written in or implemented with any of a number of programming languages, as will be appreciated by those skilled in the art.

The apparatus 100 in one example employs one or more computer-readable signal-bearing media. Examples of a computer-readable signal-bearing medium for the apparatus 100 comprise the recordable data storage medium 120 of the digital media receiver application component 110. For example, the computer-readable signal-bearing medium for the apparatus 100 comprises one or more of a magnetic, electrical, optical, biological, and atomic data storage medium. In one example, the computer-readable signal-bearing medium comprises a modulated carrier signal transmitted over a network comprising or coupled with the apparatus 100, for instance, one or more of a telephone network, a local area network (“LAN”), the internet, and a wireless network.

The steps or operations described herein are just exemplary. There may be many variations to these steps or operations without departing from the spirit of the invention. For instance, the steps may be performed in a differing order, or steps may be added, deleted, or modified.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

1. A digital media receiver, comprising:
one or more openly visible indicators that display a wireless network signal strength.

2. The digital media receiver of claim 1, further comprising a digital media receiver application component, wherein the one or more openly visible indicators comprise an openly visible indicator;
wherein the digital media receiver application component classifies the wireless network signal strength into one of a plurality of signal strength levels;
wherein the digital media receiver application component employs the openly visible indicator to display that the wireless network signal strength is at the one of the plurality of signal strength levels.

3. The digital media receiver of claim 2, wherein the openly visible indicator comprises a light emitting diode capable of displaying any one of a plurality of colors associated with the plurality of signal strength levels;
wherein the digital media receiver application component employs the light emitting diode to display one of the plurality of colors associated with the one of the plurality of signal strength levels.

4. The digital media receiver of claim 3, wherein the one of the plurality of signal strength levels comprise a first signal strength level, wherein the plurality of signal strength levels comprise a second signal strength level;
wherein upon a change in the wireless network signal strength from the first signal strength level to the second signal strength level, the digital media receiver application component changes a color of the light emitting diode to display that the wireless network signal strength is at the second signal strength level.

5. The digital media receiver of claim 2, wherein the plurality of signal strength levels comprise three or more signal strength levels;
wherein upon measurement of the wireless network signal strength, the digital media receiver application component classifies the wireless network signal strength into any one of the three or more signal strength levels;
wherein the digital media receiver application component employs the openly visible indicator to display that the wireless network signal strength is at the one of the three or more signal strength levels.

6. The digital media receiver of claim 1, further comprising a digital media receiver application component, wherein the one or more openly visible indicators comprise a plurality of light emitting diodes;
wherein the digital media receiver application component classifies the wireless network signal strength into a first signal strength level of a plurality of signal strength levels;
wherein the digital media receiver application component employs a first light emitting diode of the plurality of light emitting diodes to display that the wireless network signal strength is at the first signal strength level.

7. The digital media receiver of claim 6, wherein the plurality of signal strength levels comprise the first signal strength level, a second signal strength level, and a third signal strength level;
wherein the first light emitting diode is capable of displaying a first color associated with the first signal strength level, wherein the plurality of light emitting diodes comprise a second light emitting diode capable of displaying a second color associated with the second signal strength level and a third light emitting diode capable of displaying a third color associated with the third signal strength level;
wherein the digital media receiver application component activates the first light emitting diode if the wireless network signal strength is at the first signal strength level, the second light emitting diode if the wireless network signal strength is at the second signal strength level, and the third light emitting diode if the wireless network signal strength is at the third signal strength level.

8. The digital media receiver of claim 7, wherein upon a change in the wireless network signal strength from the first signal strength level to the second signal strength level, the digital media receiver application component switches off the first light emitting diode and switches on the second light emitting diode to display that the wireless network signal strength is at the second signal strength level.

9. The digital media receiver of claim 6, wherein the plurality of signal strength levels comprise three signal strength levels, wherein the plurality of light emitting diodes comprise three or more light emitting diodes;
wherein the digital media receiver application component classifies the wireless network signal strength into any one of the three or more signal strength levels;
wherein the digital media receiver application component employs any one or more of the three or more light emitting diodes to display that the wireless network signal strength is at the one of the three or more signal strength levels.

10. The digital media receiver of claim 1, further comprising an antenna and a digital media receiver application component;
wherein the digital media receiver application component classifies the wireless network signal strength into a first signal strength level of a plurality of signal strength levels;
wherein the digital media receiver application component sets one or more of the one or more openly visible indicators to a first indicator state to display that the wireless network signal strength is at the first signal strength level;
wherein a user adjusts a position of the antenna to cause a change in the wireless network signal strength from the first signal strength level to a second signal strength level of the plurality of signal strength levels;
wherein upon the change, the digital media receiver application component sets one or more of the one or more openly visible indicators to a second indicator state to display that the wireless network signal strength is at the second signal strength level.

11. The digital media receiver of claim 10, wherein the antenna comprises a swivel antenna, wherein the user adjusts a position of the swivel antenna to cause a change in the wireless network signal strength from the first signal strength level to the second signal strength level;
wherein upon the change, the digital media receiver application component sets one or more of the one or more openly visible indicators to the second indicator state to display that the wireless network signal strength is at the second signal strength level.

12. The digital media receiver of claim 10, wherein the one or more of the one or more antennas comprise a removable antenna, wherein the user adjusts a position of the removable antenna to cause a change in the wireless network signal strength from the first signal strength level to the second signal strength level;
wherein upon the change, the digital media receiver application component sets one or more of the one or more openly visible indicators to the second indicator state to display that the wireless network signal strength is at the second signal strength level.

13. The digital media receiver of claim 1, further comprising a digital media receiver application component, wherein the one or more openly visible indicators comprise one or more stand-alone displays;
wherein the digital media receiver application component employs the one or more stand-alone displays to allow one or more users to plainly view the wireless network signal strength.

14. The digital media receiver of claim 1, further comprising a digital media receiver application component, wherein the one or more openly visible indicators comprise one or more status bar indicators;
wherein the digital media receiver application component classifies the wireless network signal strength into one of a plurality of signal strength levels;
wherein the one or more status bar indicators comprise one or more status bar sizes, wherein the digital media receiver application component changes one or more of the one or more status bar sizes to display that the wireless network signal strength is at the one of the plurality of signal strength levels.

15. The digital media receiver of claim 1, further comprising a digital media receiver application component;
wherein the digital media receiver application component employs one or more digital media signals obtained through a wireless home network between one or more of a television, an audio/video receiver, a computer, and an alarm clock to determine the wireless network signal strength.

16. An apparatus, comprising:
a digital media receiver application component that determines a signal strength level of a wireless network signal and employs one or more openly visible indicators to display the signal strength level.

17. The apparatus of claim 16, wherein the wireless network signal comprises a wireless network signal strength;
wherein the digital media receiver application component obtains the wireless network signal strength from the wireless network signal through a wireless network card;
wherein the digital media receiver application component employs the wireless network signal strength to determine the signal strength level.

18. The apparatus of claim 17, wherein the wireless network signal comprises an audio signal, wherein the wireless network signal strength comprises an audio signal strength, wherein the signal strength level comprises an audio signal strength level;
wherein the digital media receiver application component obtains the audio signal strength from the audio signal at the wireless network card;
wherein the digital media receiver application component employs the audio signal strength to determine the audio signal strength level.

19. The apparatus of claim 18, wherein the digital media receiver application component makes a comparison of the audio signal strength level with one or more audio signal threshold values;
wherein the digital media receiver application component employs the comparison to identify one or more of the one or more audio signal threshold values that the audio signal strength level surpasses;
wherein the digital media receiver application component employs the one or more of the one or more audio signal threshold values that the audio signal strength level surpasses to display the audio signal strength level with the one or more openly visible indicators.

20. The apparatus of claim 18, wherein the digital media receiver application component employs the audio signal strength level to determine a quality of the audio signal.

21. The apparatus of claim 17, wherein the wireless network signal comprises a video signal, wherein the wireless network signal strength comprises a video signal strength, wherein the signal strength level comprises one of a plurality of video signal strength levels;
wherein the digital media receiver application component obtains the video signal strength from the video signal at the wireless network card;
wherein the digital media receiver application component employs the video signal strength to determine the video signal strength level.

22. The apparatus of claim 21, wherein the digital media receiver application component makes a comparison of the video signal strength level with one or more video signal threshold values;
wherein the digital media receiver application component employs the comparison to identify one or more of the one or more video signal threshold values that the video signal strength level surpasses;
wherein the digital media receiver application component employs the one or more of the one or more audio signal threshold values that the video signal strength level surpasses display the video signal strength level with the one or more openly visible indicators.

23. The apparatus of claim 21, wherein the digital media receiver application component employs the video signal strength level to determine a quality of the video signal.

24. The apparatus of claim 17, wherein the wireless network signal comprises a digital image signal, wherein the wireless network signal strength comprises a digital image signal strength, wherein the signal strength level comprises a digital image signal strength level;
wherein the digital media receiver application component obtains the digital image signal strength from the digital image signal at the wireless network card;
wherein the digital media receiver application component employs the digital image signal strength to determine the digital image signal strength level.

25. The apparatus of claim 24, wherein the digital media receiver application component makes a comparison of the digital image signal strength level with one or more video signal threshold values;
wherein the digital media receiver application component employs the comparison to identify one or more of the one or more video signal threshold values that the digital image signal strength level surpasses;
wherein the digital media receiver application component employs the one or more of the one or more audio signal threshold values that the digital image signal strength level surpasses to display the digital image signal strength level with the one or more openly visible indicators.

26. The apparatus of claim 24, wherein the digital media receiver application component employs the digital image signal strength level to determine a quality of the digital image signal.

27. An apparatus, comprising:
means for classifying a wireless network signal into one of a plurality of signal strength levels; and
means for openly displaying an indication that the wireless network signal is at the one of the plurality of signal strength levels.

28. The apparatus of claim 27, wherein the means for classifying the wireless network signal into the one of the plurality of signal strength levels comprise means for comparing the one of the plurality of signal strength levels with one or more signal threshold values.

29. The apparatus of claim 27, wherein the means for openly displaying the indication that the wireless network signal is at the one of the plurality of signal strength levels comprise means for openly displaying the one of the plurality of signal strength levels through the identification of one or more signal threshold values that the one of the plurality of signal strength levels surpasses.

30. A method, comprising:
classifying one or more wireless network signals employable by a digital media receiver into one or more of a plurality of signal strength levels; and
displaying the one or more of the plurality of signal strength levels with one or more openly visible indicators of the digital media receiver.

31. The method of claim 30, wherein the one or more of the plurality of signal strength levels comprise one or more of a plurality of audio signal strength levels, a plurality of video signal strength levels, and a plurality of digital image signal strength levels, wherein the step of displaying the one or more of the plurality of signal strength levels with the one or more openly visible indicators of the digital media receiver comprises the steps of:
making a comparison of the one or more of the plurality of audio signal strength levels, the plurality of video signal strength levels, and the plurality of digital image signal strength levels with one or more of an audio signal threshold value, a video signal threshold value, and a digital image signal threshold value respectively; and
employing the comparison to display that the one or more wireless network signals are at the one or more of the plurality of audio signal strength levels, the plurality of video signal strength levels, and the plurality of digital image signal strength levels with the one or more openly visible indicators.

32. The method of claim 31, wherein the one or more of the audio signal threshold value, the video signal threshold value, and the digital image signal threshold value comprise one or more of a first audio signal threshold value, a first video signal threshold value, and a first digital image signal threshold value, wherein the step of making the comparison of the one or more of a plurality of audio signal strength levels, a plurality of video signal strength levels, and a plurality of digital image signal strength levels with the one or more of the audio signal threshold value, the video signal threshold value, and the digital image signal threshold value comprises the steps of:
making the comparison of the one or more of the plurality of audio signal strength levels, the plurality of video signal strength levels, and the plurality of digital image signal strength levels with the first audio signal threshold value, the first video signal threshold value, and the first digital image signal threshold value respectively;
employing the comparison to determine if the one or more of the plurality of audio signal strength levels, the plurality of video signal strength levels, and the plurality of digital image signal strength levels surpass the first audio signal threshold value, the first video signal threshold value, and the first digital image signal threshold value respectively; and
displaying one or more of the one or more of the plurality of audio signal strength levels, the plurality of video signal strength levels, and the plurality of digital image signal strength levels that surpass the first audio signal threshold value, the first video signal threshold value, and the first digital image signal threshold value with one or more of the one or more openly visible indicators at a first indicator state.

33. The method of claim 32, wherein the one or more of the audio signal threshold value, the video signal threshold value, and the digital image signal threshold value comprise one or more of a second audio signal threshold value, a second video signal threshold value, and a second digital image signal threshold value, the method further comprising the steps of:
making the comparison of the one or more of the plurality of audio signal strength levels, the plurality of video signal strength levels, and the plurality of digital image signal strength levels with the second audio signal threshold value, the second video signal threshold value, and the second digital image signal threshold value respectively;
employing the comparison to determine if the one or more of the plurality of audio signal strength levels, the plurality of video signal strength levels, and the plurality of digital image signal strength levels surpass the second audio signal threshold value, the second video signal threshold value, and the second digital image signal threshold value respectively; and
displaying one or more of the one or more of the plurality of audio signal strength levels, the plurality of video signal strength levels, and the plurality of digital image signal strength levels that surpass the second audio signal threshold value, the second video signal threshold value, and the second digital image signal threshold value with one or more of the one or more openly visible indicators at a second indicator state.

34. The method of claim 33, wherein the one or more of the audio signal threshold value, the video signal threshold value, and the digital image signal threshold value comprise one or more of a third audio signal threshold value, a third video signal threshold value, and a third digital image signal threshold value, the method further comprising the steps of:
making the comparison of the one or more of the plurality of audio signal strength levels, the plurality of video signal strength levels, and the plurality of digital image signal strength levels with the third audio signal threshold value, the third video signal threshold value, and the third digital image signal threshold value respectively; and
employing the comparison to determine if one or more of the plurality of audio signal strength levels, the plurality of video signal strength levels, and the plurality of digital image signal strength levels surpass the third audio signal threshold value, the third video signal threshold value, and the third digital image signal threshold value respectively; and
displaying one or more of the one or more of the plurality of audio signal strength levels, the plurality of video signal strength levels, and the plurality of digital image signal strength levels that surpass the third audio signal threshold value, the third video signal threshold value, and the third digital image signal threshold value with one or more of the one or more openly visible indicators at a third indicator state.

35. The method of claim 30, wherein the one or more wireless network signals comprise a wireless network signal, wherein the one or more of the plurality of signal strength levels comprise a signal strength level, wherein the step of classifying the one or more wireless network signals employable by the digital media receiver into the one or more of the plurality of signal strength levels comprises the steps of:
obtaining a wireless network signal strength of the wireless network signal from a wireless network card; and
employing the wireless network signal strength to determine the signal strength level.

36. The method of claim 35, wherein the step of employing the wireless network signal strength to determine the signal strength level comprises the steps of:
classifying the wireless network signal strength into the signal strength level; and
displaying that the wireless network signal strength is at the signal strength level with one or more of the one or more openly visible indicators at a first indicator state.

37. The method of claim 36, wherein the signal strength level comprises a first signal strength level, the method further comprising the steps of:
classifying the wireless network signal strength into a second signal strength level; and
displaying that the wireless network signal strength is at the second signal strength level with one or more of the one or more openly visible indicators at a second indicator state upon the wireless network signal strength changing to the second signal strength level.

38. The method of claim 36, wherein the signal strength level comprises a first signal strength level, wherein the step of classifying the wireless network signal strength into the signal strength level comprises the steps of:
classifying the wireless network signal strength into a second signal strength level upon a user repositioning one or more antennas; and
displaying that the wireless network signal strength is at the second signal strength level with one or more of the one or more openly visible indicators at a second indicator state upon the wireless network signal strength changing to the second signal strength level.

39. An article, comprising:
one or more computer-readable signal-bearing media; and
means in the one or more media for classifying one or more wireless network signals employable by a digital media receiver into one or more of a plurality of signal strength levels; and
means in the one or more media for displaying the one or more of the plurality of signal strength levels with one or more openly visible indicators of the digital media receiver.
